(19) United States
(12) Patent Application Publication
(10) Pub. No.: US 2023/0122373 A1
(43) Pub. Date: Apr. 20, 2023

(54) METHOD FOR TRAINING DEPTH ESTIMATION MODEL, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Xiaoqing Ye, Beijing (CN); Hao Sun, Beijing (CN)

(73) Assignee: BEIJING BAIDU NETCOM SCIENCE TECHNOLOGY CO., LTD., Beijing (CN)

(21) Appl. No.: 18/083,272

(22) Filed: Dec. 16, 2022

Related U.S. Application Data
(63) Continuation of application No. PCT/CN2022/075104, filed on Jan. 29, 2022.

(30) Foreign Application Priority Data
Jun. 8, 2021 (CN) 202110639017.1

(51) Int. Cl. G06T 7/55

(52) U.S. Cl. CPC G06T 7/55; G06T 2207/10028; G06T 2207/20081

(57) ABSTRACT

A method for training a depth estimation model includes: obtaining sample images; generating sample depth images and sample residual maps corresponding to the sample images; determining sample photometric error information corresponding to the sample images based on the sample depth images; and obtaining a target depth estimation model by training an initial depth estimation model based on the sample images, the sample residual maps and the sample photometric error information.

### CROSS-REFERENCE TO RELATED APPLICATION

This application is a continuation of International Application No. PCT/CN2022/075104, filed on Jan. 29, 2022, which is based on and claims priority to Chinese Patent Application No. 202110639017.1, filed on Jun. 8, 2021, the entire content of which is incorporated herein by reference.

### TECHNICAL FIELD

The disclosure relates to the field of artificial intelligence (AI) technologies, especially the field of deep learning and computer vision technologies, and can be applied to image processing and recognition scenes, in particular to a method for training a depth estimation model, an electronic device, and a storage medium.

### BACKGROUND

AI is a subject that studies using computers to simulate certain human thinking processes and intelligent behaviors (such as learning, reasoning, thinking, and planning), which has both the hardware-level technology and the software-level technology. The AIhardware technology includes technologies such as sensor, special AI chip, cloud computing, distributed storage, and big data processing. The AI software technology includes computer vision, speech recognition technology, natural language processing technology, machine learning/deep learning, big data processing technology, and knowledge map technology.

In the related art, depth estimation can be divided into monocular depth estimation and binocular depth estimation. According to a supervision state, depth estimation can be divided into monocular supervised depth estimation and monocular unsupervised depth estimation. The monocular unsupervised depth estimation requires the help of additional information, such as attitude information and optical flow information of the front and back frame video sequences.

### SUMMARY

According to a first aspect of the disclosure, a method for training a depth estimation model is provided. The method includes: obtaining sample images; generating sample depth images and sample residual maps corresponding to the sample images; determining sample photometric error information corresponding to the sample images based on the sample depth images; and obtaining a target depth estimation model by training an initial depth estimation model based on the sample images, the sample residual maps and the sample photometric error information.

According to a second aspect of the disclosure, a depth estimation method is provided. The method includes: obtaining an image to be estimated; and obtaining a target depth image output by the target depth estimation model trained by the above method for training a depth estimation model by inputting the image to be estimated into the target depth estimation model, in which the target depth image includes target depth information.

According to a third aspect of the disclosure, an electronic device is provided. The electronic device includes: at least one processor and a memory communicatively coupled to the at least one processor. The memory stores instructions executable by the at least one processor, and when the instructions are executed by the at least one processor, the method for training a depth estimation model of the first aspect of the disclosure or the depth estimation method of the second aspect of the disclosure is implemented.

According to a fourth aspect of the disclosure, a non-transitory computer-readable storage medium having computer instructions stored thereon is provided. The computer instructions are configured to cause a computer to implement the method for training a depth estimation model of the first aspect of the disclosure or the depth estimation method of the second aspect of the disclosure.

It should be understood that the content described in this section is not intended to identify key or important features of embodiments of the disclosure, nor is it intended to limit the scope of the disclosure. Additional features of the disclosure will be easily understood based on the following description.

### BRIEF DESCRIPTION OF THE DRAWINGS

The drawings are used to better understand solutions and do not constitute a limitation to the disclosure, in which:

FIG. 1 is a schematic diagram of a first embodiment of the disclosure.

FIG. 2 is a schematic diagram of a second embodiment of the disclosure.

FIG. 3 is a schematic diagram of a third embodiment of the disclosure.

FIG. 4 is a schematic diagram of an application scenario in an embodiment of the disclosure.

FIG. 5 is a schematic diagram of a fourth embodiment of the disclosure.

FIG. 6 is a schematic diagram of a fifth embodiment of the disclosure.

FIG. 7 is a schematic diagram of a sixth embodiment of the disclosure.

FIG. 8 is a schematic diagram of a seventh embodiment of the disclosure.

FIG. 9 is a schematic diagram of an example electronic device for implementing a method for training a depth estimation model according to an embodiment of the disclosure.

### DETAILED DESCRIPTION

The following describes embodiments of the disclosure with reference to the accompanying drawings, which includes various details of the embodiments of the disclosure to facilitate understanding and shall be considered merely exemplary. Therefore, those skilled in the art should recognize that various changes and modifications can be made to the embodiments described herein without departing from the scope and spirit of the disclosure. For clarity and conciseness, descriptions of well-known functions and structures are omitted in the following description.

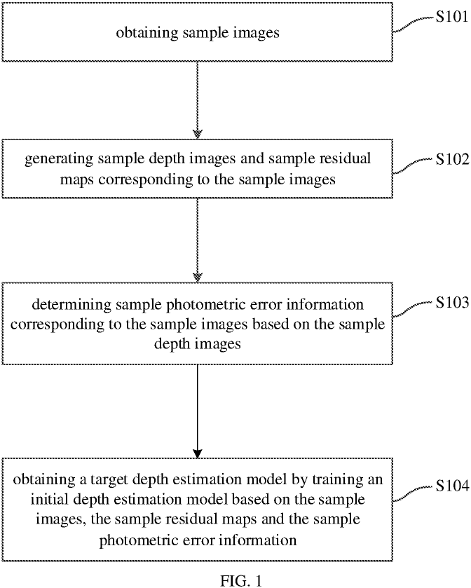

FIG. 1 is a schematic diagram of a first embodiment of the disclosure.

It should be noted that the executive body of the method for training a depth estimation model of some embodiments of the disclosure is an apparatus for training a depth estimation model. The apparatus can be realized by software and/or hardware. The apparatus can be configured in an electronic device. The electronic device includes but not limited to a terminal or a server.

Some embodiments of the disclosure relate to the field of AI technologies, especially the field of deep learning and computer vision technologies, and can be applied to image processing and recognition scenes.

Artificial intelligence is abbreviated as AI, which is a new technical science that studies and develops theories, methods, technologies and application systems used to simulate, extend and expand human intelligence.

Deep learning is to learn internal laws and representation levels of sample data. The information obtained in the learning process is very helpful to the interpretation of data such as texts, images and sounds. The ultimate goal of deep learning is to enable machines to have the same analytical learning ability as people, and to be able to recognize words, images, sounds and other data.

Computer vision refers to using cameras and computers instead of human eyes to identify, track and measure targets, and to further perform graphics processing, so that the images after computer processing can become images more suitable for human eyes to observe or for transmission to instruments for detection.

For example, in the image processing and recognition scenes, the image to be processed is recognized by using some hardware devices or software calculation and processing logic, to identify the corresponding image features. The image features are used to assist subsequent detection and application. The method for training a depth estimation model of some embodiments of the disclosure is applied to the image processing and recognition scenes. Therefore, the method effectively facilitates to improve the expression and modeling ability of the trained depth estimation model for image depth features, so as to improve the depth estimation effect of the depth estimation model. In addition, the training efficiency of the hardware device for the depth estimation model can be effectively improved, and the depth estimation effect of the depth estimation model is greatly improved.

As illustrated in FIG. 1, the method for training a depth estimation model includes the following steps.

In S101, sample images are obtained.

The images used to train the depth estimation model can be called the sample images. There may be one or more sample images. The sample images can also be part of video frame images extracted from the plurality of video frames, which is not limited.

The above obtained sample images can be used to assist in the subsequent training of the depth estimation model. The sample images can also be the images captured by the binocular imaging device, for example, the sample images I^{L} and I^{R} are captured by the left-ocular imaging device and the right-ocular imaging device respectively.

Before training the depth estimation model based on the sample images, the sample images I^{L} and I^{R} can also be calibrated to ensure the subsequent training effect of the depth model.

In S102, sample depth images and sample residual maps corresponding to the sample images are generated.

After the sample images are obtained, depth recognition can be performed on the sample images, and depth images, which can be called sample depth images, can be generated based on the recognized depths.

After the sample images are obtained, the residual map method can be used to process the sample images, and the processed residual maps can be used as the sample residual maps.

The residual map method is to adjust each pixel value according to certain rules. For example, the image data are normalized by the spectral vector geometric mean, to obtain the relative reflectivity. Alternatively, the maximum value of each band in the whole image (representing the measurement of 100 reflectivity) is selected, and the maximum value of each band is subjected by the normalized average radiation value, which is not limited.

The above generated sample depth images and sample residual maps corresponding to the sample images can be used as reference annotation in the process of training the depth estimation model, so as to help reduce the acquisition and annotation cost of training data required for training the depth estimation model, and to effectively avoid relying on too much external image information. Therefore, the learning and modeling ability of the depth estimation model can be effectively ensured, and the training cost of the depth estimation model can be significantly reduced.

In S103, sample photometric error information corresponding to the sample images is determined based on the sample depth images.

In some embodiments of the disclosure, after the sample depth images and the sample residual maps corresponding to the sample images are generated, the sample photometric error information corresponding to the sample images can be analyzed with reference to the sample depth images. The sample photometric error information can be used to assist in training the depth estimation model.

An image photometric degree can be understood as a lightness degree of the image, and the photometric error information can be determined according to the sample images I^{L} and I^{R} captured by the left-ocular imaging device and the right-ocular imaging device respectively. The photometric error information can be used to describe an error between a calculated lightness and an actual lightness in the process of image lightness recognition.

The sample photometric error information can be the photometric error information as the training reference annotation in the process of training the depth estimation model.

The mode of obtaining the sample photometric error information can be illustrated as follows.

The sample images include a first sample image and a second sample image. The first sample image is different from the second sample image. The first sample image and the second sample image can correspond to the sample images I^{L} and I^{R} respectively. Therefore, the theoretical sample parallax image can be determined according to the sample depth image. The relation between the sample depth image and the sample parallax image satisfies the following formula:

In the binocular imaging device, when the baseline between the two binoculars is B and the focal length of the imaging device is f, the corresponding sample parallax image Dis is:

$$D i s = \frac{B ∗ f}{D} ;$$

The sample parallax information corresponding to each pixel in the sample parallax image Dis meets the followings:

$${D}_{g t} \left(u , v\right) = {I}^{R} \left(u + D i {s}^{s t a g e 1} \left(u , v\right) , v\right) - {I}^{L} \left(u , v\right) ;$$

Based on the sample image I^{L} and the sample depth image Dis^{stage1}estimated by the network, I^{R'} = Dis^{stage1} + I^{L} can be solved by reverse solution, and then the photometric error information is calculated based on the calculated I^{R'} and the sample image I^{R}, as the sample photometric error information.

Certainly, any other possible mode can also be used to determine the sample photometric error information corresponding to the sample images according to the sample depth images, such as, model matching, engineering, and image processing, which is not limited.

In S104, a target depth estimation model is obtained by training an initial depth estimation model based on the sample images, the sample residual maps and the sample photometric error information.

After the sample photometric error information corresponding to the sample images is determined according to the sample depth images, the target depth estimation model is obtained by training the initial depth estimation model based on the sample images, the sample residual maps and the sample photometric error information.

For example, the sample images can be input into the initial depth estimation model to obtain the prediction depth information output from the initial depth estimation model, the prediction depth information is used to assist in determining the prediction residual maps and the prediction photometric error information, so that the loss value can be fitted according to the prediction residual maps, the prediction photometric error information, the sample residual maps and the sample photometric error information. Based on the loss value, the initial depth estimation model can be trained to obtain the target depth estimation model, which is not limited.

In some embodiments of the disclosure, the sample images are obtained. The sample depth images and sample residual maps corresponding to the sample images are generated. The sample photometric error information corresponding to the sample images is determined based on the sample depth images. The target depth estimation model is obtained by training the initial depth estimation model based on the sample images, the sample residual maps and the sample photometric error information. Therefore, the method effectively facilitates to improve the expression and modeling ability of the trained depth estimation model for image depth features, so as to improve the depth estimation effect of the depth estimation model.

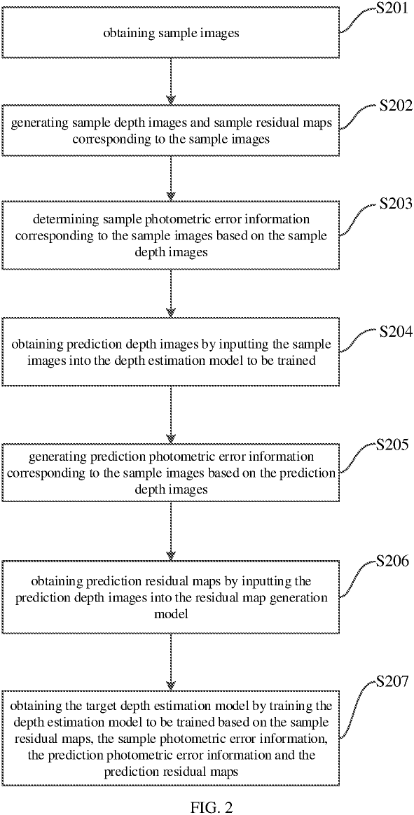

FIG. 2 is a schematic diagram of a second embodiment of the disclosure.

As illustrated in FIG. 2, the method for training a depth estimation model includes the following steps.

In S201, sample images are obtained.

In S202, sample depth images and sample residual maps corresponding to the sample images are generated.

In S203, sample photometric error information corresponding to the sample images is determined based on the sample depth images.

The description of S201-S203 can be specifically referred to the above embodiments, and will not be repeated herein.

In some embodiments of the disclosure, a method for training a depth estimation model is provided. In some embodiments of the disclosure, the initial depth estimation model includes a depth estimation model to be trained and a residual map generation model that are sequentially connected.

That is, the initial depth estimation model in some embodiments of the disclosure is composed of the depth estimation model to be trained and the residual map generation model. By configuring a series-connected lightweight residual map generation model for the depth estimation model to be trained, the estimation effect of the depth estimation model can be greatly improved without increasing additional computing amount.

The depth estimation model to be trained can be configured to support the corresponding image processing of the monocular sample images to estimate the prediction depth information corresponding to the monocular sample images.

The depth estimation model to be trained can be, for example, an AI model, such as, a neural network model or a machine learning model, which is not limited.

In S204, prediction depth images are obtained by inputting the sample images into the depth estimation model to be trained.

The series-connected lightweight residual map generation model is configured for the above depth estimation model to be trained. The residual map generation model can process the input depth images to obtain the corresponding residual maps.

That is, the depth estimation model to be trained is configured with the series-connected lightweight residual map generation model. The depth estimation model to be trained corresponds to stage1 network in the first stage, and the residual map generation model corresponds to stage2 network in the second stage. In some embodiments of the disclosure, the prediction result of the stage2 network (since the stage2 network corresponds to the residual map generation model, the prediction result of the stage2 network can be called the prediction residual map) can be used as a pseudo supervision signal of the stage1 network, to further refine the training processing logic for the stage1 network.

Thus, the sample images can be input into the depth estimation model to be trained, to obtain the prediction depth images output by the depth estimation model to be trained, that is, the prediction depth image D^{stage1} output by the stage1 network in the first stage.

In S205, prediction photometric error information corresponding to the sample images is generated based on the prediction depth images.

After inputting the sample images into the depth estimation model to be trained to obtain the prediction depth images output by the depth estimation model to be trained, the prediction photometric error information corresponding to the sample images can be generated according to the prediction depth images.

The photometric error information obtained by analyzing the photometric error of the original sample images according to the prediction depth images, can be called the prediction photometric error information.

The prediction photometric error information can be combined with the sample photometric error information to fit the loss value of the photometric error dimension, and the loss value of the photometric error dimension can be used for subsequent assisting in training of the depth estimation model.

In some embodiments, according to the prediction depth images, the prediction photometric error information corresponding to the sample images is generated, which can be that, the prediction parallax images corresponding to the prediction depth images are generated, and the prediction parallax information is analyzed from the prediction parallax images, and the prediction photometric error information corresponding to the sample images is generated according to the sample images and the prediction parallax information. Thus, the prediction photometric error information can be quickly and accurately analyzed, and the prediction photometric error information can be used to assist in fitting the loss value of the photometric error dimension.

In some embodiments, the prediction parallax images can be obtained based on the logical calculation relation between the prediction depth images and the predicted parallax images. The parallax information obtained by analyzing the prediction parallax images can be called the prediction parallax information.

For example, the prediction parallax images can be input into a pre-trained analyzing model to obtain the prediction parallax information output by the analyzing model, or the prediction parallax images can be analyzed in any other possible way to obtain the prediction parallax information, which is not limited.

After the prediction parallax images corresponding to the prediction depth images are generated and the prediction parallax information is analyzed from the prediction parallax images, the prediction photometric error information corresponding to the sample images can be generated according to the sample images and the prediction parallax information.

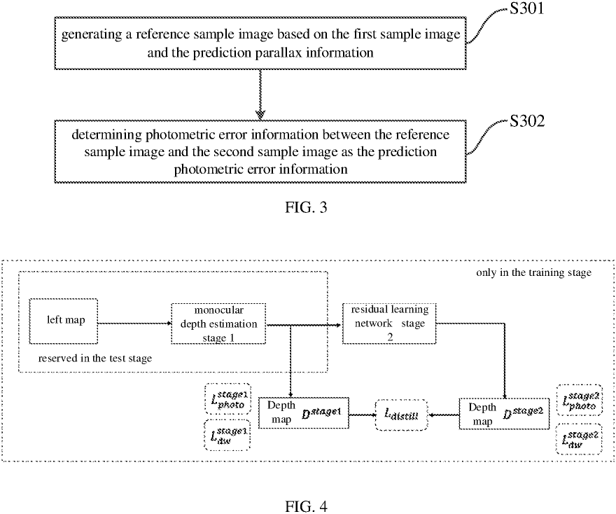

In some embodiments, as illustrated in FIG. 3, FIG. 3 is a schematic diagram of a third embodiment of the disclosure. Generating the prediction photometric error information corresponding to the sample images according to the sample images and the prediction parallax information includes the following steps.

In S301, a reference sample image is generated based on the first sample image and the prediction parallax information.

After the prediction parallax information is analyzed from the prediction parallax images, the reference sample image can be generated based on the first sample image and the prediction parallax information.

The reference image used to train the depth estimation model can be referred to as the reference sample image.

For example, the sample image includes the first sample image I^{L} and the second sample image I^{R} (the first sample image is captured by the left-ocular imaging device and the second sample image is captured by the right-ocular imaging device). The reference sample image can be calculated according to the first sample image I^{L} and the prediction parallax information Dis^{stage1}. The specific calculation method is as follows:

$${I}^{R} {}^{′} = D i {s}^{s t a g e 1} + {I}^{L}$$

where I^{R'} can be used to represent the reference sample image.

In S302, photometric error information between the reference sample image and the second sample image is determined as the prediction photometric error information.

After the reference sample image is generated according to the first sample image and the prediction parallax information, the photometric error information between the reference sample image and the second sample image can be determined as the prediction photometric error information.

That is, the photometric error information between the reference sample image and the second sample image can be determined based on the above calculated reference sample image 1^{R'} and the second sample image, as the prediction photometric error information. The specific calculation method is as follows:

$${L}_{p h o t o} = \left|{I}^{R} - {I}^{R} {}^{′}\right|$$

Lₚₕₒₜₒ represents the prediction photometric error information.

In some embodiments of the disclosure, the reference sample image is generated according to the first sample image and the prediction parallax information, and then the photometric error information between the reference sample image and the second sample image is determined as the prediction photometric error information. Thus, the prediction photometric error information can be more accurately obtained, so that the prediction photometric error information can effectively assist the training process of the depth estimation model. The prediction photometric error information can be used to fit the loss value of the photometric error dimension of the depth estimation model, thereby ensuring the accuracy of the determination of the convergence timing of the depth estimation model, and effectively assisting in improving the training effect of the depth estimation model.

In S206, prediction residual maps are obtained by inputting the prediction depth images into the residual map generation model.

In some embodiments of the disclosure, inputs of the stage2 network (the residual map generation model) are the prediction depth images learned by the stage1 network (the depth estimation model to be trained) and the sample images, and outputs of the stage2 network are the prediction residual maps, which can be recorded as D_{residual}, then the overall output of the stage2 network (the residual graph generation model) is:

$${D}^{s t a g e 2} = {D}^{s t a g e 1} + {D}_{r e s i d u a l} ;$$

The overall output of the stage2 network (the residual map generation model) is expressed as: a sum of the prediction depth image D^{stage1} output by the stage1 network and the prediction residual map D_{residual}.

The result of D^{stage2} obtained above is better than that of D^{stage1}, but D^{stage2} increases the amount of calculation compared with the result of D^{stage1}.

Thus, in some embodiments, the output result of the stage2 network can be used as the pseudo supervision signal of the stage1 network training to further refine the stage1 network. The auto-distillation loss function is recorded as: L_{distill} = |D ^{stage2} ^{_} D^{stage1}|.

In S207, the target depth estimation model is obtained by training the depth estimation model to be trained based on the sample residual maps, the sample photometric error information, the prediction photometric error information and the prediction residual maps.

After the sample residual maps, the sample photometric error information and the prediction photometric error information are obtained, the target depth estimation model is obtained by training the depth estimation model to be trained based on the sample residual maps, the sample photometric error information, the prediction photometric error information and the prediction residual maps.

That is, in the process of training the target depth estimation model, the depth estimation model to be trained of the stage1 network is obtained by training, that is, the prediction residual map of the stage2 network is used as the pseudo supervision training signal of the stage1 network, so as to further refine the training processing logic for the stage1 network, to greatly improve the estimation effect of the depth estimation model on the premise of avoiding additional computation amount.

In some embodiments, the depth estimation model to be trained is trained according to the sample residual maps, the sample photometric error information, the prediction photometric error information and the prediction residual maps. The photometric loss value between the prediction photometric error information and the sample photometric error information is determined. The residual loss value between the prediction residual maps and the sample residual maps is determined. The target loss value is determined according to the photometric loss value and residual loss value. In response to the target loss value being less than a loss value threshold, the trained depth estimation model to be trained is used as the target depth estimation model. In some embodiments of the disclosure, the convergence timing of the depth estimation model is determined by referring to the loss function of multiple dimensions, which can greatly improve the accuracy of the determination of the convergence timing. In addition, in the process of training, bidirectional transformation consistency between the left-ocular sample image and the right-ocular sample image is used as reference, which can effectively improve the robustness of the depth estimation model.

In some embodiments of the disclosure, a bidirectional consistency loss function can also be added to obtain the corresponding loss value by fitting the above sample residual maps, the sample photometric error information, the prediction photometric error information and the prediction residual maps.

For example, in the same small batch, the same initial depth estimation model processes the left-ocular sample image and the right-ocular sample image, to obtain

$${D}_{p r e d}^{L}$$

and

$${D}_{p r e d}^{R}$$

estimated by the initial depth estimation model. In some embodiments of the disclosure, a bidirectional transformation loss function may be designed in advance for the initial depth estimation model.

Through the bidirectional transformation loss function, the following calculation process can be performed. Firstly, for any point P in the left-ocular sample image, according to the prediction parallax image

$${D}_{p r e d}^{L}$$

corresponding to the left-ocular sample image, the corresponding mapping point p̃in the right-ocular sample image can be obtained. At the same time, based on the estimated prediction parallax image

$${D}_{p r e d}^{R}$$

corresponding to the right-ocular sample image, it is deduced that the position of point p̃in the right-ocular sample image may be mapped back to the left-ocular sample image, which is p̂. Usually, p̂ should coincide with P. Therefore, in some embodiments of the disclosure, the photometric error information can be used to measure the loss value of the photometric error dimension:

$${L}_{d w} = \left|{I}^{L} \left(p\right) - {I}^{L} \left(\hat{p}\right)\right| ;$$

The loss function of the loss value of the fitted photometric error dimension can act on the stage1 network and the stage2 network respectively.

Thus, in some embodiments of the disclosure, in the process of training the depth estimation model to be trained, the overall loss function can be recorded as:

$${L}_{a l l} = {L}_{d w}^{s t a g e 1} + {L}_{d w}^{s t a g e 2} + {L}_{p h o t o}^{s t a g e 1} + {L}_{p h o t o}^{s t a g e 2} + {L}_{d i s t i l l} ;$$

$${L}_{d w}^{s t a g e 1}$$

represents the corresponding photometric loss value of the stage1 network,

$${L}_{d w}^{s t a g e 2}$$

represents the corresponding photometric loss value of the stage2 network,

$${L}_{p h o t o}^{s t a g e 1}$$

represents the loss value of the image prediction dimension corresponding to the stage1 network,

$${L}_{p h o t o}^{s t a g e 2}$$

represents the loss value of the image prediction dimension corresponding to the stage2 network, L_{distill} represents the residual loss value between the prediction residual map and the sample residual map.

In some embodiments of the disclosure, the above stage1 network can support the corresponding image processing for the monocular sample images to estimate the prediction depth information corresponding to the monocular sample images, so as to accurately determine the timing of model convergence, and improve the accuracy of the monocular unsupervised depth estimation based on the auto-distillation method without increasing the computing resource costs, so that the depth estimation effect can be greatly improved.

As illustrated in FIG. 4, FIG. 4 is a schematic diagram of an application scenario in some embodiments of the disclosure. In FIG. 4, any sample image can be input into the stage1 network of the depth estimation model, to obtain the prediction depth image D^{stage1} corresponding to the sample image output from the stage1 network of the depth estimation model, and the prediction depth image D^{stage2} output from the stage2 network of the residual map generation model, and then L_{distill} is obtained based on the prediction depth image D^{stage2} and the prediction depth image D^{stage1}. Training of supervised depth estimation model is performed in combination with

$${L}_{d w}^{s t a g e 1} ,$$

$${L}_{p h o t o}^{s t a g e 1}$$

corresponding to the stage 1 network and

$${L}_{d w}^{s t a g e 2} , {L}_{p h o t o}^{s t a g e 2}$$

corresponding to the stage 2 network.

In some embodiments of the disclosure, the sample images are obtained. The sample depth images and sample residual maps corresponding to the sample images are generated. The sample photometric error information corresponding to the sample images is determined based on the sample depth images. The target depth estimation model is obtained by training the initial depth estimation model based on the sample images, the sample residual maps and the sample photometric error information. Therefore, the method effectively facilitates to improve the expression and modeling ability of the trained depth estimation model for image depth features, so as to improve the depth estimation effect of the depth estimation model. In the process of training the target depth estimation model, the above depth estimation model to be trained of the stage1 network is obtained by training, that is, the prediction residual maps of the stage2 network are determined as the pseudo supervision training signals of the stage1 network, so as to further refine the training processing logic for the stage1 network, which can greatly improve the estimation effect of the depth estimation model on the premise of avoiding increasing additional computation amount. The convergence timing of the depth estimation model is determined based on the loss function of multiple dimensions, the accuracy of the determination of the convergence timing can be greatly improved. In the process of training, the bi-directional transformation consistency between the left-ocular sample image and the right-ocular sample image is referred, which can effectively improve the robustness of the depth estimation model.

FIG. 5 is a schematic diagram of a fourth embodiment of the disclosure.

As illustrated in FIG. 5, the depth estimation method includes the following steps.

In S501, an image to be estimated is obtained.

The current image to be estimated can be called the image to be estimated.

There may be one or more images to be estimated, and the image to be estimated can also be part of the video frame images extracted from multiple video frames, which is not limited.

In S502, a target depth image is obtained by inputting the image to be estimated into the target depth estimation model trained by the method for training a depth estimation model, the target depth image includes target depth information.

After the image to be estimated is obtained, the image to be estimated can be input into the target depth estimation model trained by the method for training a depth estimation model to obtain the target depth image output by the target depth estimation model.

In some embodiments of the disclosure, the image to be estimated is obtained. The target depth image is obtained by inputting the image to be estimated into the target depth estimation model trained by the method for training a depth estimation model, the target depth image includes target depth information. Since the target depth estimation model is trained based on the sample residual map and the sample photometric error information, when the target depth estimation model is used to process the image to be estimated, it can express and model a more accurate target depth image and improve the depth estimation effect of the depth estimation model.

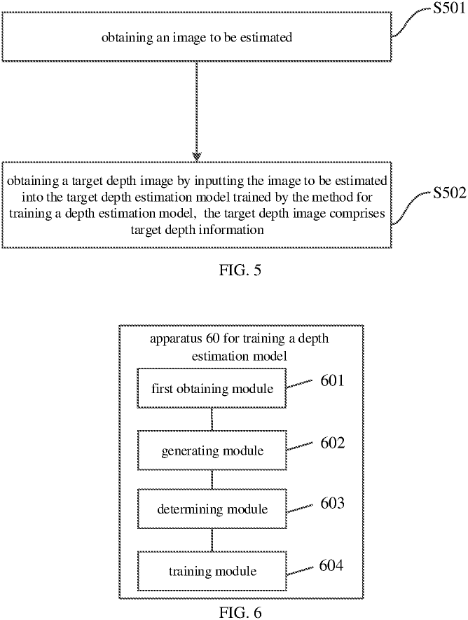

FIG. 6 is a schematic diagram of a fifth embodiment of the disclosure.

As illustrated in FIG. 6, the apparatus for training a depth estimation model 60 includes: a first obtaining module 601, a generating module 602, a determining module 603 and a training module 604.

The first obtaining module 601 is configured to obtain sample images.

The generating module 602 is configured to generate sample depth images and sample residual maps corresponding to the sample images.

The determining module 603 is configured to determine sample photometric error information corresponding to the sample images based on the sample depth images.

The training module 604 is configured to obtain a target depth estimation model by training an initial depth estimation model based on the sample images, the sample residual maps and the sample photometric error information.

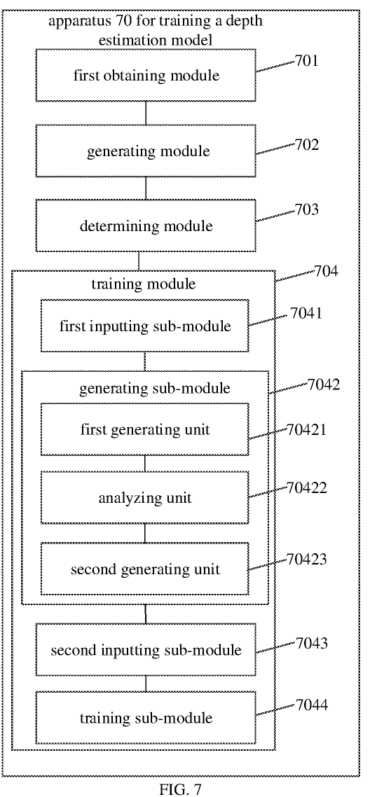

In some embodiments of the disclosure, as illustrated in FIG. 7, FIG. 7 is a schematic diagram of a sixth embodiment of the disclosure. The apparatus for training a depth estimation model 70 includes: a first obtaining module 701, a generating module 702, a determining module 703 and a training module 704.

The training module 704 includes: a first inputting sub-module 7041, a generating sub-module 7042, a second inputting sub-module 7043 and a training sub-module 7044.

The first inputting sub-module 7041 is configured to obtain prediction depth images by inputting the sample images into the depth estimation model to be trained.

The generating sub-module 7042 is configured to generate prediction photometric error information corresponding to the sample images based on the prediction depth images.

The second inputting sub-module 7043 is configured to obtain prediction residual maps by inputting the prediction depth images into the residual map generation model.

The training sub-module 7044 is configured to obtain the target depth estimation model by training the depth estimation model to be trained based on the sample residual maps, the sample photometric error information, the prediction photometric error information and the prediction residual maps.

In some embodiments of the disclosure, the training sub-module 7044 is further configured to: determine a photometric loss value between the prediction photometric error information and the sample photometric error information; determine a residual loss value between the prediction residual maps and the sample residual maps; determine a target loss value based on the photometric loss value and the residual loss value; and determine the trained depth estimation model to be trained as the target depth estimation model, in response to the target loss value being less than a loss value threshold.

In some embodiments of the disclosure, as illustrated in FIG. 7, the generating sub-module 7042 includes: a first generating unit 70421, an analyzing unit 70422 and a second generating unit 70423.

The first generating unit 70421 is configured to generate prediction parallax images corresponding to the prediction depth images.

The analyzing unit 70422 is configured to obtain prediction parallax information by analyzing the prediction parallax images.

The second generating unit 70423 is configured to generate the prediction photometric error information corresponding to the sample images based on the sample images and the prediction parallax information.

In some embodiments of the disclosure, the second generating unit 70423 is further configured to: generate a reference sample image based on the first sample image and the prediction parallax information; and determine photometric error information between the reference sample image and the second sample image as the prediction photometric error information.

It can be understood that the apparatus for training a depth estimation model 70 in FIG. 7 of this embodiment and the apparatus for training a depth estimation model 60 in the above embodiment, the first obtaining module 701 and the first obtaining module 601, the generating module 702 and the generating module 602, the determining module 703 and the determining module 603, the training module 704 and the training module 604 in the above embodiments have the same function and structure.

It should be noted that the above explanation of the method for training a depth estimation model is also applicable to the apparatus for training a depth estimation model of this embodiment.

In some embodiments of the disclosure, the sample images are obtained. The sample depth images and sample residual maps corresponding to the sample images are generated. The sample photometric error information corresponding to the sample images is determined based on the sample depth images. The target depth estimation model is obtained by training an initial depth estimation model based on the sample images, the sample residual maps and the sample photometric error information. Therefore, the method effectively facilitates to improve the expression and modeling ability of the trained depth estimation model for image depth features, so as to improve the depth estimation effect of the depth estimation model.

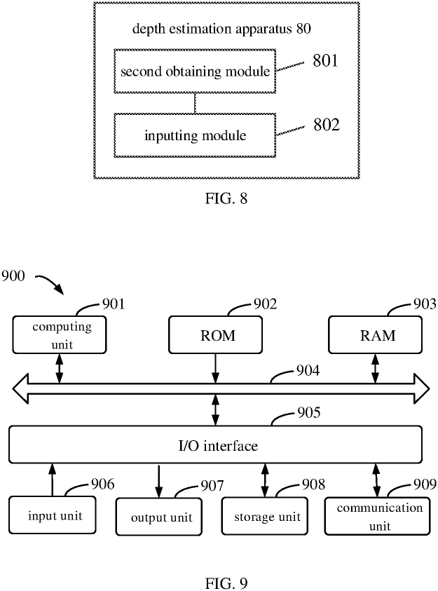

FIG. 8 is a schematic diagram of a seventh embodiment of the disclosure.

As illustrated in FIG. 8, the depth estimation apparatus 80 includes: a second obtaining module 801 and an inputting module 802.

The second obtaining module 801 is configured to obtain an image to be estimated.

The inputting module 802 is configured to obtain a target depth image by inputting the image to be estimated into the target depth estimation model trained by the method for training a depth estimation model, in which the target depth image includes target depth information.

It should be noted that the foregoing explanation of the depth estimation method is also applicable to the depth estimation apparatus of this embodiment, and will not be repeated here.

In some embodiments of the disclosure, the image to be estimated is obtained. The image to be estimated is input into the target depth estimation model trained by the method for training a depth estimation model to obtain the target depth image output by the target depth estimation model. The target depth image includes target depth information. Since the target depth estimation model is trained based on the sample residual maps and the sample photometric error information, when the trained target depth estimation model is used to process the image to be estimated, it can express and model a more accurate target depth image, so as to improve the depth estimation effect of the depth estimation model.

It should be noted that all embodiments of the disclosure can be implemented alone or in combination with other embodiments, which are considered as the protection scope required by the disclosure.

According to the embodiments of the disclosure, the disclosure also provides an electronic device, a readable storage medium and a computer program product.

FIG. 9 is a block diagram of an example electronic device for implementing the method for training a depth estimation model according to the embodiments of the disclosure.

Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 9, the device 900 includes a computing unit 901 performing various appropriate actions and processes based on computer programs stored in a read-only memory (ROM) 902 or computer programs loaded from the storage unit 908 to a random access memory (RAM) 903. In the RAM 903, various programs and data required for the operation of the device 900 are stored. The computing unit 901, the ROM 902, and the RAM 903 are connected to each other through a bus 904. An input/output (I/O) interface 905 is also connected to the bus 904.

Components in the device 900 are connected to the I/O interface 905, including: an inputting unit 906, such as a keyboard, a mouse; an outputting unit 907, such as various types of displays, speakers; a storage unit 908, such as a disk, an optical disk; and a communication unit 909, such as network cards, modems, and wireless communication transceivers. The communication unit 909 allows the device 900 to exchange information/data with other devices through a computer network such as the Internet and/or various telecommunication networks.

The computing unit 901 may be various general-purpose and/or dedicated processing components with processing and computing capabilities. Some examples of computing unit 901 include, but are not limited to, a central processing unit (CPU), a graphics processing unit (GPU), various dedicated AI computing chips, various computing units that run machine learning model algorithms, and a digital signal processor (DSP), and any appropriate processor, controller and microcontroller. The computing unit 901 executes the various methods and processes described above, such as the method for training a depth estimation model or the depth estimation method.

For example, in some embodiments, the method for training a depth estimation model or the depth estimation method may be implemented as a computer software program, which is tangibly contained in a machine-readable medium, such as the storage unit 908. In some embodiments, part or all of the computer program may be loaded and/or installed on the device 900 via the ROM 902 and/or the communication unit 909. When the computer program is loaded on the RAM 903 and executed by the computing unit 901, one or more steps of the method for training a depth estimation model or the depth estimation method described above may be executed. Alternatively, in other embodiments, the computing unit 901 may be configured to perform the method for training a depth estimation model or the depth estimation method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and the block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve the defects of difficult management and weak business scalability in the traditional physical host and virtual private server (VPS) service. The server can also be a server of distributed system or a server combined with block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, subcombinations and substitutions can be made according to design requirements and other factors. Any modification, equivalent replacement and improvement made within the spirit and principle of the disclosure shall be included in the protection scope of the disclosure.

1. A method for training a depth estimation model, comprising:
obtaining sample images;
generating sample depth images and sample residual maps corresponding to the sample images;
determining sample photometric error information corresponding to the sample images based on the sample depth images; and
obtaining a target depth estimation model by training an initial depth estimation model based on the sample images, the sample residual maps and the sample photometric error information.

2. The method of claim 1, wherein the initial depth estimation model comprises a depth estimation model to be trained and a residual map generation model that are sequentially connected;
obtaining the target depth estimation model by training the initial depth estimation model based on the sample images, the sample residual maps and the sample photometric error information, comprises:
obtaining prediction depth images by inputting the sample images into the depth estimation model to be trained;
generating prediction photometric error information corresponding to the sample images based on the prediction depth images;
obtaining prediction residual maps by inputting the prediction depth images into the residual map generation model; and
obtaining the target depth estimation model by training the depth estimation model to be trained based on the sample residual maps, the sample photometric error information, the prediction photometric error information and the prediction residual maps.

3. The method of claim 2, wherein obtaining the target depth estimation model by training the depth estimation model to be trained based on the sample residual maps, the sample photometric error information, the prediction photometric error information and the prediction residual maps, comprises:
determining a photometric loss value between the prediction photometric error information and the sample photometric error information;
determining a residual loss value between the prediction residual maps and the sample residual maps;
determining a target loss value based on the photometric loss value and the residual loss value; and
determining the trained depth estimation model to be trained as the target depth estimation model, in response to the target loss value being less than a loss value threshold.

4. The method of claim 2, wherein generating the prediction photometric error information corresponding to the sample images based on the prediction depth images, comprises:
generating prediction parallax images corresponding to the prediction depth images;
obtaining prediction parallax information by analyzing the prediction parallax images; and
generating the prediction photometric error information corresponding to the sample images based on the sample images and the prediction parallax information.

5. The method of claim 4, wherein the sample images comprise a first sample image and a second sample image, and the first sample image is different from the second sample image;
generating the prediction photometric error information corresponding to the sample images based on the sample images and the prediction parallax information comprises:
generating a reference sample image based on the first sample image and the prediction parallax information; and
determining photometric error information between the reference sample image and the second sample image as the prediction photometric error information.

6. The method of claim 1, comprising:
obtaining an image to be estimated; and
obtaining a target depth image by inputting the image to be estimated into the target depth estimation model, wherein the target depth image comprises target depth information.

7. An electronic device, comprising:
a processor; and
a memory communicatively coupled to the processor; wherein,
the memory is configured to store instructions executable by the processor, and the processor is configured to execute the instructions to:
obtain sample images;
generate sample depth images and sample residual maps corresponding to the sample images;
determine sample photometric error information corresponding to the sample images based on the sample depth images; and
obtain a target depth estimation model by training an initial depth estimation model based on the sample images, the sample residual maps and the sample photometric error information.

8. The device of claim 7, wherein the processor is configured to execute the instructions to:
obtain the target depth estimation model by training the initial depth estimation model based on the sample images, the sample residual maps and the sample photometric error information, comprises:
obtain prediction depth images by inputting the sample images into the depth estimation model to be trained;
generate prediction photometric error information corresponding to the sample images based on the prediction depth images;
obtain prediction residual maps by inputting the prediction depth images into the residual map generation model; and
obtain the target depth estimation model by training the depth estimation model to be trained based on the sample residual maps, the sample photometric error information, the prediction photometric error information and the prediction residual maps.

9. The device of claim 8, wherein the processor is configured to execute the instructions to:
determine a photometric loss value between the prediction photometric error information and the sample photometric error information;
determine a residual loss value between the prediction residual maps and the sample residual maps;
determine a target loss value based on the photometric loss value and the residual loss value; and
determine the trained depth estimation model to be trained as the target depth estimation model, in response to the target loss value being less than a loss value threshold.

10. The device of claim 8, wherein the processor is configured to execute the instructions to:
generate prediction parallax images corresponding to the prediction depth images;
obtain prediction parallax information by analyzing the prediction parallax images; and
generate the prediction photometric error information corresponding to the sample images based on the sample images and the prediction parallax information.

11. The device of claim 10, wherein the processor is configured to execute the instructions to:
generate the prediction photometric error information corresponding to the sample images based on the sample images and the prediction parallax information comprises:
generate a reference sample image based on the first sample image and the prediction parallax information; and
determine photometric error information between the reference sample image and the second sample image as the prediction photometric error information.

12. The device of claim 7, wherein the processor is configured to execute the instructions to:
obtain an image to be estimated; and
obtain a target depth image by inputting the image to be estimated into the target depth estimation model trained by a method for training a depth estimation model, comprising:
obtaining sample images;
generating sample depth images and sample residual maps corresponding to the sample images;
determining sample photometric error information corresponding to the sample images based on the sample depth images; and
obtaining a target depth estimation model by training an initial depth estimation model based on the sample images, the sample residual maps and the sample photometric error information,
wherein the target depth image comprises target depth information.

13. A non-transitory computer-readable storage medium having computer instructions stored thereon, wherein the computer instructions are configured to cause a computer to execute a method for training a depth estimation model, the method comprising:
obtaining sample images;
generating sample depth images and sample residual maps corresponding to the sample images;
determining sample photometric error information corresponding to the sample images based on the sample depth images; and
obtaining a target depth estimation model by training an initial depth estimation model based on the sample images, the sample residual maps and the sample photometric error information.

14. The non-transitory computer-readable storage medium of claim 13, wherein the initial depth estimation model comprises a depth estimation model to be trained and a residual map generation model that are sequentially connected;
obtaining the target depth estimation model by training the initial depth estimation model based on the sample images, the sample residual maps and the sample photometric error information, comprises:
obtaining prediction depth images by inputting the sample images into the depth estimation model to be trained;
generating prediction photometric error information corresponding to the sample images based on the prediction depth images;
obtaining prediction residual maps by inputting the prediction depth images into the residual map generation model; and
obtaining the target depth estimation model by training the depth estimation model to be trained based on the sample residual maps, the sample photometric error information, the prediction photometric error information and the prediction residual maps.

15. The non-transitory computer-readable storage medium of claim 14, wherein obtaining the target depth estimation model by training the depth estimation model to be trained based on the sample residual maps, the sample photometric error information, the prediction photometric error information and the prediction residual maps, comprises:
determining a photometric loss value between the prediction photometric error information and the sample photometric error information;
determining a residual loss value between the prediction residual maps and the sample residual maps;
determining a target loss value based on the photometric loss value and the residual loss value; and
determining the trained depth estimation model to be trained as the target depth estimation model, in response to the target loss value being less than a loss value threshold.

16. The non-transitory computer-readable storage medium of claim 14, wherein generating the prediction photometric error information corresponding to the sample images based on the prediction depth images, comprises:
generating prediction parallax images corresponding to the prediction depth images;
obtaining prediction parallax information by analyzing the prediction parallax images; and
generating the prediction photometric error information corresponding to the sample images based on the sample images and the prediction parallax information.

17. The non-transitory computer-readable storage medium of claim 16, wherein the sample images comprise a first sample image and a second sample image, and the first sample image is different from the second sample image;
generating the prediction photometric error information corresponding to the sample images based on the sample images and the prediction parallax information comprises:
generating a reference sample image based on the first sample image and the prediction parallax information; and
determining photometric error information between the reference sample image and the second sample image as the prediction photometric error information.

18. The non-transitory computer-readable storage medium of claim 13, wherein the method further comprises:
obtaining an image to be estimated; and
obtaining a target depth image by inputting the image to be estimated into the target depth estimation model, wherein the target depth image comprises target depth information.
